(19) United States
(12) Patent Application Publication
(10) Pub. No.: US 2014/0279208 A1
(43) Pub. Date: Sep. 18, 2014

(54) ELECTRONIC SHOPPING SYSTEM AND SERVICE

(71) Applicant: Rosie, Ithica, NY (US)

(72) Inventors: Nickita Michael NICKITAS, Old Greenwich, CT (US); Michael John Remmer RYZEWIC, New York, NY (US)

(73) Assignee: Rosie, Ithica, NY (US)

(21) Appl. No.: 14/213,303

(22) Filed: Mar. 14, 2014

Related U.S. Application Data
(60) Provisional application No. 61/783,945, filed on Mar. 14, 2013.

(51) Int. Cl. G06Q 30/06

(52) U.S. Cl. CPC G06Q 30/0631
USPC 705/26.7

(57) ABSTRACT

Systems and methods are described for providing an electronic shopping system/service. A computer server for providing an electronic shopping service includes a purchase predictive data collector configured to collect purchase predictive data of a user, a product purchase interval predictor configured to predict a product purchase interval of a product for the user at least partially based on the purchase predictive data of the user, and a product recommender configured to recommend additional products to the user at least partially based on the purchase predictive data of the user and to provide data analytics and shopper marketing to retailers, wholesalers, or consumer packaged goods (CPG) companies.

### RELATED APPLICATIONS

This application claims priority to U.S. Provisional Application No. 61/783,945, entitled “Electronic Shopping System and Service”, filed on Mar. 14, 2013, which is incorporated herein in its entirety.

### BACKGROUND

Electronic systems or services are available for assisting consumer purchasing, e.g., grocery shopping. Some systems or services can offer static reminders about when to order household goods (e.g., milk, paper towels, etc.). A static reminder is usually a calendar entry that can alert the user to make a purchase for an item. These systems or services generally require the user to create and manage the static reminders. Systems or services using static reminders normally demand high user involvement, do not provide individualized service, and do not consider users' purchasing history and behaviors.

### SUMMARY

The subject matter disclosed herein is generally related to electronic systems and services. In accordance with the disclosed subject matter, systems and methods are described for providing an electronic shopping system/service.

Disclosed subject matter includes, in one aspect, a computer server for providing an electronic shopping service, which includes a purchase predictive data collector configured to collect purchase predictive data of a user, a product purchase interval predictor configured to predict a product purchase interval of a product for the user at least partially based on the purchase predictive data of the user, and a product recommender configured to recommend additional products to the user at least partially based on the purchase predictive data of the user and to provide data analytics and shopper marketing to retailers, wholesalers, or consumer packaged goods (CPG) companies.

In some embodiments, the purchase predictive data collector is further configured to normalize the purchase predictive data of the user.

In some other embodiments, the product purchase interval predictor is further configured to calculate a user product lifetime and a final product lifetime.

In some other embodiments, the product purchase interval predictor is further configured to consider an action of delaying purchase of the product by the user when predicting the product purchase interval of the product for the user.

In some other embodiments, the product purchase interval predictor is further configured to consider a last purchase of the product by the user when predicting the product purchase interval of the product for the user.

In some other embodiments, the product recommender is further configured to consider purchases by other users when recommending the additional products to the user.

In some other embodiments, the product recommender is further configured to identify the other users based on their similarities to the user.

In some other embodiments, the product recommender is further configured to identify purchasing opportunities to increase sales for at least one of the retailers, the wholesalers, or the CPG companies.

In some other embodiments, the product recommender is further configured to analyze customers of the electronic shopping service.

In some other embodiments, the computer server for providing an electronic shopping service also includes a dynamic aisle manager configured to maintain a dynamic aisle for the user.

In some other embodiments, the dynamic aisle manager is further configured to add the additional products to the dynamic aisle for the user.

In some other embodiments, the computer server for providing an electronic shopping service also includes a third-party integration interface configured to interact with at least one third-party.

In some other embodiments, the at least one third-party includes at least one of a retailer, a wholesaler, and a consumer packaged goods (CPG) company.

Disclosed subject matter includes, in another aspect, a computerized method of providing electronic shopping service, which includes automatically collecting purchase predictive data of a user by a purchase predictive data collector, predicting a product purchase interval of a product for the user at least partially based on the purchase predictive data of the user by a product purchase interval predictor, recommending additional products to the user at least partially based on the purchase predictive data of the user by a product recommender, and providing data analytics and shopper marketing to retailers, wholesalers, or consumer packaged goods (CPG) companies.

In some embodiments, the computerized method of providing electronic shopping service also includes normalizing the purchase predictive data of the user.

In some embodiments, the computerized method of providing electronic shopping service also includes calculating a user product lifetime and a final product lifetime.

In some embodiments, the computerized method of providing electronic shopping service also includes considering an action of delaying purchase of the product by the user when predicting the product purchase interval of the product for the user.

In some embodiments, the computerized method of providing electronic shopping service also includes considering a last purchase of the product by the user when predicting the product purchase interval of the product for the user.

In some embodiments, the computerized method of providing electronic shopping service also includes considering purchases by other users when recommending the additional products to the user.

In some embodiments, the computerized method of providing electronic shopping service also includes identifying the other users based on their similarities to the user.

In some embodiments, the computerized method of providing electronic shopping service also includes identifying purchasing opportunities to increase sales for at least one of the retailers, the wholesalers, or the CPG companies.

In some embodiments, the computerized method of providing electronic shopping service also includes interacting with at least one third-party.

In some embodiments, the at least one third-party includes at least one of a retailer, a wholesaler, and a consumer packaged goods (CPG) company.

These and other capabilities of embodiments of the disclosed subject matter will be more fully understood after a review of the following figures, detailed description, and claims.

### BRIEF DESCRIPTION OF THE DRAWINGS

FIG. 1 illustrates a schematic diagram of an exemplary system environment according to some embodiments of the disclosed subject matter.

FIG. 2 illustrates a schematic diagram of another exemplary system environment according to some embodiments of the disclosed subject matter.

FIG. 3 illustrates an exemplary system architecture according to some embodiments of the disclosed subject matter.

FIG. 4 illustrates an exemplary process of predicting product due date according to some embodiments of the disclosed subject matter.

FIG. 5 illustrates an exemplary process of recommending products according to some embodiments of the disclosed subject matter.

FIG. 6 illustrates examples of user profile characteristics and lists of products bought.

FIG. 7 illustrates an exemplary three-dimension space according to some embodiments of the disclosed subject matter.

FIG. 8 illustrates a block diagram of an exemplary electronic shopping service engine according to some embodiments of the disclosed subject matter.

FIG. 9 illustrates a block diagram of an exemplary computing device.

FIGS. 10A through 10C illustrate sample web application screens during operation of an exemplary system according to some embodiments of the disclosed subject matter.

FIGS. 11A through 11C illustrate sample mobile application screens during operation of another exemplary system according to some embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the embodiments described below are only examples, and that it is contemplated that there are other systems and methods that are within the scope of the disclosed subject matter.

According to certain embodiments of the disclosed subject matter, an electronic shopping system/service can save customers time, money, and stress by predicting household items they need, before they run out, and ordering them from local grocers and online retailers. Customers can access the electronic shopping system/service on their mobile phones or through web (e.g., www.rosieapp.com). The electronic shopping system/service can include a web and mobile shopping platform that learns the customers' purchasing behavior for household goods and groceries.

According to certain embodiments of the disclosed subject matter, an electronic shopping system/service can know what items the customers are running out of even before the customers realize, and can send a friendly reminder to help out the customers. The electronic shopping system/service can save customers time through the convenience of shopping from anywhere and finding the lowest price in the customers' area. The electronic shopping system/service's prediction capability can be based on a recommendation engine and based on machine learning concepts. The electronic shopping system/service can tailor a customer's shopping experience precisely to the customer's needs. The electronic shopping system/service can make personalized recommendations for the items that the customer wants, and can even rearrange the entire store to shop for items in a way that makes the most sense to customers. With dynamic aisles, customers can search for breakfast, frozen, barbecue, organic and many others, and the electronic shopping system/service can curate an aisle containing the items most relevant to the customer's search and preferences.

According to certain embodiments of the disclosed subject matter, an electronic shopping system/service can offer intuitive and user-friendly interfaces which make shopping easier than ever before. The electronic shopping system/service can keep track of a customer's favorite items so the customer can find them quickly and never run out of groceries.

One exemplary use of an electronic shopping system/service is illustrated below.
1) A customer downloads the electronic grocery shopping application because it saves time, money, and stress by predicting the household items the customer needs, before the customer runs out, and allows the customer to order them at the lowest price.
2) The customer connects the app to the customer's online retailer/grocer accounts (e.g., local grocery store, Amazon Prime, Wal-Mart, Target, etc.).
3) The customer wants to buy an item (i.e. toothpaste), so the customer goes into the app and search for it or scan barcode right off the item. The customer finds the one that he/she wants and add it to my cart.
4) The customer checks out via the electronic grocery shopping application, the order is processed, fulfilled, and delivered by the online or local retailer/grocery the customer has selected.
5) The next time the customer opens the electronic grocery shopping application, the electronic grocery shopping application recommends items based on what the customer is running out of.
6) After X weeks/months, the customer gets a notification message saying, e.g., “I think you're running out of some items. [CLICK HERE] to see what I would like to send you.”
7) The customer opens the app and see his/her favorites in his/her cart at the lowest price available from his/her favorite vendors.
8) The customer clicks “BUY IT” and the items arrive at his/her door before he/she has run out.

According to certain embodiments of the disclosed subject matter, an electronic shopping system/service can offer many benefits to customers. The electronic shopping system/service can include a web and mobile shopping app that learns purchasing behavior for household goods and groceries. It can save customers time, money, and stress by predicting the items needed before the customers run out, and ordering them from local grocers and online retailers. The electronic shopping system/service can
Learn customers' preferences and ensure customers never run out of the items needed.
Help customers avoid hours of time and stress wandering around the store.
Offer fast, smart, convenient shopping on phone, tablet, or PC.
Place orders available for in-store pickup or delivery through partnerships with retailers, 3^{rd} party vendors, or provided by Rosie Applications Inc.
Find the lowest prices from customers' favorite grocers.
Provide discounts delivered right to customers' fingertips.

According to certain embodiments of the disclosed subject matter, an electronic shopping system/service can offer many benefits to vendors (e.g., local grocers or online retailers, etc.). The electronic shopping system/service can provide predictive intelligence, analytics, and data sophistication for online and mobile consumer-intelligent data analytics and shopper marketing. The electronic shopping system/service can increase margins by up to 60% in an industry where profit margins are less than 2%. Customers use can use the electronic shopping system/service to save time, money, and stress by predicting the groceries and household items they need, before they run out, and ordering them through local grocers and online retailers. Customers can use the electronic shopping system/service on their phone,

tablet, or PC and orders are available for in-store pickup.

Customers use the electronic shopping system/service because it can provide household intelligence and supply chain management for their lives. Average online orders are 3 to 5 times larger than in-store purchases. Online grocery sales are outpacing other sales channels with year-over-year increases greater than 11%. Personalized marketing drives increased basket size, shopping visits, and retention over time.

According to certain embodiments of the disclosed subject matter, an electronic shopping system/service can offer competitive advantages to retailers, such as
Acquire customers through online and mobile shopping delivered right to their fingertips.
Target customers with specific promotions to encourage them to add those items to their baskets.
Mine data to search for shoppers who have purchasing “gaps of opportunity”.
Engage consumer packaged goods (CPG) data analytics and shopper marketing funds through powerful tools and predictive intelligence.

According to certain embodiments of the disclosed subject matter, an electronic shopping system/service can offer variable pricing models to wholesalers, retailers, and/or CPG companies. The variable pricing models can change the prices on goods to encourage customers to purchase them and to increase net sales to wholesalers, retailers, and/or CPG companies. In one example, elasticity of demand for each individual product can be used to determine the price for a product. Different products can have different sales behavior with respect to changing prices. For example, some products are very responsive to changes in price whereas other products are not responsive to changes in price. By using this information, the items that are most responsive to changes in price can be marked up the most and the items that are least responsive to price can be marked up the least. For certain products there is a very weak relationship between price and quantity; in this case, the product can marked up by some fixed amount.

One implementation of this approach is described here. For each of the UPCs that have been purchased, as well as the UPCs from a given retailer that account for the top (e.g., 80%) of products sold, the number of units sold/time unit (e.g., per day) are organized by the distinct price points at which a product is sold. For example, if Coca-Cola was sold at $1.00, $2.00, $3.00, . . . $6.00, the average daily quantity is calculated for each of those prices. Using the average daily quantity as the dependent variable, a linear regression is fit to the daily quantity by price. Then the Root Mean Squared Error (RMSE) comparing the linear fit to the actual data points is calculated. Models with a RMSE value above a certain threshold are considered invalid and the default price value is used in that case. For each of the different UPCs in the above list, an entry in a relational table titled ‘upc_price’ is created. This table can contain four items: UPC id, the slope and linear intercept of the linear fit, a Boolean field titled is_valid that refers to the RMSE being less than the threshold. The price is then calculated based entirely on the current price of the product. Given a UPC and the current price, the database is queried for the fields mentioned above associated with that UPC. A dense range of values above the given price is constructed. For each of these prices, the estimated quantity (based on the slope and intercept) is multiplied by the difference between that price and the given price to get the expected marginal sales. The price point associated with the highest marginal sales is then chosen and the price is calculated by dividing that point with the given price.

According to certain embodiments of the disclosed subject matter, an electronic shopping system/service can transform the retail industry by empowering retailers to engage customers through predictive intelligence and data sophistication. The electronic shopping system/service can offer retailers the ability to identify what shoppers want to buy before they make a purchase, and a platform for placing actionable marketing messages at their fingertips.

According to certain embodiments of the disclosed subject matter, an electronic shopping system/service can provide local grocers and online retailers the ability to:
Enable shoppers to collaborate as group or household to order their favorite items collectively.
Subscribe consumers to automatic purchasing of the items they need, before they run out.
Create a closer relationship with customers through personalized and efficient data analytics and shopper marketing.
Optimize discounts on a per customer basis.
Form alliances with Consumer Packaged Goods companies to provide promotional offers.
Share recipes with patrons and allow them to purchase all the ingredients they need in a single click.
Measure and improve sales through metrics and data-driven decision making.

According to certain embodiments of the disclosed subject matter, an electronic shopping system/service can provide a cutting edge e-commerce and data analytics platform that drives customer engagement. Online grocery sales are outpacing other sales channels with year-over-year increases greater than 11%. In some situations, average online orders can be 3 to 5 times larger than in-store purchases. Data analytics and shopper marketing can drive increased basket size, shopping visits, and retention over time. An electronic shopping system/service according to certain embodiments of the disclosed subject matter can provide data analytics and shopper marketing. For example, it can help understand how one's target consumers behave as shoppers, identify purchasing “gaps of opportunity” to drive increased sales, and send one-to-one personalized messages with relevant promotions & reminders to customers.

Some exemplary analysis performed by an electronic shopping system/service according to certain embodiments of the disclosed subject matter are described in Tables 1-7 listed below.

TABLE 1
Customer Demographics Analysis

| Purpose | Understand breakdown of customer base by | |
|---|---|---|
| | traditional demographic measures. | |
| | Identify likely demographics for growth in customer base. | |
| Design | Pie charts demonstrate breakdown of customers by gender | |
| | and nationality. | |
| | Histograms demonstrate distribution of customer age | |
| | and income level | |
| | Can break down by store, loyalty/non-loyalty data. | |
| Required | Customer | First Name, Last Name |
| Data | Information | Zip Code |

TABLE 2
Customer Latent Demand Analysis

| Purpose | Increase the number of transactions by identifying latent demand | |
|---|---|---|
| | (substitutions or stock-outs). | |
| | Illustrate difference in demand (e.g. demand for particular items or from | |
| | particular market segments) between products sold in-store and products sold | |
| | online. | |
| | Optimize inventory by identifying prevalence of over-stocking or stock-outs | |
| | of products. | |
| Design | Interactive diagram showing flow of demand for each product (or product | |
| | type) through in-store and online sales channels to each market segment. | |
| | For each product, links are drawn from the product through various sales | |
| | channels to individual market segments (or customer types). | |
| | Size (height) of each product is determined as the quantity of the product in | |
| | inventory relative to the total products in inventory. | |
| | Size (height) of each market segment determined as percentage of the | |
| | population represented by that market segment within the area/region serviced | |
| | by the store. | |
| | Link width shows the quantity of items purchased by customers of a particular | |
| | market segment relative to the total quantity of that item in inventory. | |
| | Nodes can be moved to show overlapping demand or to compare product | |
| | demand. | |
| Required | Product Inventory | Quantity of product in inventory (beginning of |
| | | period) |
| Date | Customer | First Name, Last Name |
| | Information | Zip Code |
| | Transaction History | Date |
| | | Product UPCs |
| | | Customer ID (unique transactions are identifiable |
| | | and relatable to an individual customer) |
| | Product Information | UPC |
| | | Price |
| | | Category/Department |
| Optional | Pricing Information | COGS |
| Data | | Other (depending on desired type of market |
| | | segmentation) |

TABLE 3
Customer Lifetime Value (CLV) Over Time Analysis

| Purpose | Increase the number and size of transactions. | |
|---|---|---|
| | Identify age groups with few number of transactions, small basket sizes, and | |
| | low CLVs. | |
| Design | Bubble represents a customer of a particular age with a particular customer | |
| | lifetime value (CLV). | |
| | Bubble size reflects relative magnitude of average basket size for particular | |
| | customer. | |
| | Upon hover, customer bubble shows age, gender, average basket size ($), and | |
| | CLV. | |
| | CLV vs. Customer age vs. Average basket size can be adjusted over time. | |
| | GOAL: Increase the no., size, and height of bubbles (customers) over time. | |
| Required | Customer | First Name, Last Name |
| Data | Information | Zip Code |
| | Transaction History | Date |
| | | Product UPCs |
| | | Customer ID (unique transactions are identifiable |
| | | and relatable to an individual customer) |
| | Product Information | UPC |
| | | Price |
| | | Category/Department |
| Optional | Pricing Information | COGS |
| Data | | |

TABLE 4
E-Commerce Opportunities Analysis

| Purpose | Project revenue opportunity from implementing e-commerce | |
|---|---|---|
| | at a store | |
| | Identify likely demographics for growth in customer base. | |
| | Tailor marketing efforts to better reach online and in-store | |
| | customers. | |
| | Stacked histograms demonstrate distribution of age amongst | |
| | in-store and online customers. | |
| | Projected revenue chart broken down by in-store and online | |
| | sales. | |
| Required | Customer Information | First Name, Last Name |
| Data | | Zip Code |
| | Transaction History | Date |
| | | Product UPCs |
| | | Customer ID (unique transactions are |
| | | identifiable and relatable to an |
| | | individual customer) |

TABLE 5
Customer Traits Cluster Analysis

| Purpose | Understand customer behavior and baskets on a per store per customer basis. | |
|---|---|---|
| | Use purchase history to cluster types of customers. | |
| | Identify growing and high-value groups to inform company strategy and | |
| | priorities. | |
| | Targeted 1-to-1 marketing to increase sales and build customer relationships | |
| Design | Interactive diagram shows relationships between customer archetypes and | |
| | purchasing habits. | |
| | View using data from one store, a group of stores, or all stores. | |
| | Clicking on individual bubbles gives more information about group's traits, | |
| | number of members, growth rate, median basket size, and popular products. | |
| | Colors represent overall groups, individual bubbles represent sub-groups | |
| | Customer bubble is sized based on total sales volume. | |
| Required | Customer-Specific | First Name, Last Name |
| Data | Information | Zip Code |
| | Transaction History | Date |
| | | Product UPCs |
| | | Customer ID (unique transactions are identifiable |
| | | and relatable to an individual customer) |
| | | Transaction ID |
| | | Store Location |
| | Product Information | UPC |
| | | Price |
| | | Category/Department |

TABLE 6
Product Sales and Promotions Analysis

| Purpose | Predict promotions success by item, age range, gender, and time of year. | |
|---|---|---|
| | Increase efficacy of advertised and in-store promotions by optimizing product | |
| | choice and timing for sales on a per store basis. | |
| | Attract more customers into stores and increase the value of customers | |
| | already shopping. | |
| Design | Line graphs to display historical data for any UPC. Total daily sales are | |
| | plotted with category sales data for comparison. | |
| | Hovering over data points gives total sales for that day/week/month as well as | |
| | average price for that period. | |
| | Sales and promotional periods indicated on the graph. | |
| | Can break down sales by store, age, gender. | |
| | Include a list of top picks for best choice of products to put on promotion this | |
| | week. | |
| Required | Customer-Specific | First Name, Last Name |
| Data | | Zip Code |
| | Transaction History | Date |
| | | Product UPCs |
| | | Customer ID (unique transactions are identifiable |
| | | and relatable to an individual customer) |
| | Product Information | Transaction ID |
| | | Price History |

TABLE 7
Product Relationship Analysis

| Purpose | Find clusters of items that people tend to buy together for pricing/marketing | |
|---|---|---|
| | strategy of “bundled” offerings. | |
| | Drive revenue by implementing complementary pricing strategies where one | |
| | item is discounted and the other's price is slightly increased. | |
| | Use to create in-store displays and arrangements to encourage purchasing | |
| | multiple items and drive larger basket sizes. | |
| Design | Search functionality to look up any product by UPC. | |
| | Hovering over data points gives a score indicating the strength of the | |
| | association. | |
| | Top picks list give a sample of our best choices for associated items that | |
| | week. | |
| | Able to break down by store. | |
| | Link between associated products shows that multiple items are frequently | |
| | bought together. | |
| Required | Transaction History | Date |
| Data | | Product UPCs |
| | | Transaction ID |
| | | Location |

According to certain embodiments of the disclosed subject matter, an electronic shopping system/service can analyze user purchase behavior on both an individual and collective level. The electronic shopping system/service can include living and evolving piece of software based on machine learning concepts, that can shape itself to users, and strive for even greater accuracy. The electronic shopping system/service can grow smarter and provide better answers without disrupting the rest of the electronic grocery shopping ecosystem. The electronic shopping system/service can be built on a service-based model that can respond to new data inputs as they become available. When a user tracks a new product via the electronic shopping system/service, the electronic shopping system/service can estimate when it will be needed again. When a user indicates that he or she is out of a product, recently purchased a product, or has enough of a product recommended for purchase, the electronic shopping system/service can generate a new reorder date based on the previous interval and an adjustment period based on user and product characteristics. The electronic shopping system/service can also prioritize and organize search results on the website and mobile app based on a user's past behavior.

The disclosed subject matter can be implemented in a networked computing environment. FIG. 1 illustrates a schematic diagram of an exemplary electronic shopping system environment 100 according to one embodiment of the disclosed subject matter. The system environment 100 can include a network 102, a server 104, and one or more clients 106 (e.g., client 106-1, 106-2, . . . 106-N). The system environment 100 can also include third-party resources 108. The clients 106 and the server 104 can be directly or indirectly coupled to the network 102 and communicate among each other via the network 102, which can be wired, wireless, or a combination of both. Alternatively, the clients 106 can directly or indirectly communicate with each other.

Each client 106 can include a desktop computer, a mobile computer, a tablet computer, a cellular device, a smartphone, or any computing systems or devices that are capable of performing computation. The server 104 can also include a desktop computer, a mobile computer, a tablet computer, a cellular device, a smartphone, or any computing systems or devices that are capable of performing computation. Although FIG. 1 shows the server 104 as a single server, the server 104 can include more than one physical and/or logical servers. The network 102 can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks can be implemented with any number of hardware and software components, transmission media and network protocols. FIG. 1 shows the network 102 as a single network; however, the network 102 can include multiple interconnected networks listed above.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (e.g., the network 102).

The disclosed subject matter can also be implemented in another exemplary electronic shopping system environment 200 as illustrated in FIG. 2. The system environment 200 can include a predictive database 210, a recommendation engine 220, a recommendation engine API 230, a customer facing backend 240, a live database 250, 3^{rd} party integrations (e.g., social media, blogs, websites, etc.) 260, a front-end API 270, a web application 280, and a mobile application 290. The predictive database 210 can store collected customer predictive data collected from their shopping and purchasing data via the service, as well as on other services connected via the 3^{rd} party integrations 260. The recommendation engine 220 can make use of these data to predict the items that the user is likely to run out of and the items that should be recommended to the user. The recommendation engine API 230 can abstract interactions with the predictive database 210 and the recommendation engine 220, allowing changes to one or more components of the system without affect others. The customer facing backend 240 can use the live database 250 to store all data necessary for interactions with the users. Predictive data can be transferred to and from the predictive database 210 via the recommendation engine API 230. The front end API 270 can allow the web application 280 and the mobile application 290 to interact with the custom facing backend 240. This is one possible arrangement of systems to allow for the collection and maintenance of large amounts of predictive data and computationally intensive analytics without adversely affecting the latency of the user experience.

FIG. 3 illustrates an exemplary system architecture 300 according to some embodiments of the disclosed subject matter. The exemplary system architecture 300 can include a database 310 (e.g., a Rosie database), an API layer 320, an interface layer 330, a RosieApp Recommendation Engine (RARE) 340, a RARE scheduler 350, and a frontend 360. The database 310 can store customer predictive information, including purchase history and website interactions, as well as any additional data which may be collected and considered predictive. The API layer 320 can provide a consistent access format to the database 310, allowing the interface layer 330 to access data and format it appropriately for the RARE 340. The RARE 340 can predict user purchasing behavior and product recommendations. The RARE scheduler 350 can control when and on what set(s) of data the RARE 340 operations. The frontend 360 can allow for monitoring of the activities of the system.

According to certain embodiments of the disclosed subject matter, an electronic shopping system/service can collect, log, and analyze customer shopping data that is “predictive” of their future preferences, behavior, and needs. These data can also be used to target advertising and promotional deals to appropriate consumer. The data collected can include:
Customer profile data from registration and any connected sites (including age, sex, location, size of household)
Customer purchases on the electronic shopping system/service website and the mobile app
Customer interactions with the recommendation system, including: “delay purchase”, “purchased elsewhere”, “track item”, “stop tracking item”, and the entry of estimated item purchase intervals
Customer searches for an item on the website
Customer views an item on the website (for how long, do they click on additional images or additional detail)
In store purchases based on loyalty card and store-brand credit card data from partners
Purchase data from store inventory and point of sale (POS) system records
Customer purchase data imported from other online shopping websites
Customer data from uploaded receipts
Customer social network data (shares, “likes”, friends, etc.)
Customer ratings of products
Customer comments on products
Proprietary research and survey data generated in-house on consumer purchasing behavior
Customer recipes and shopping lists generated and shared using the website, mobile app, or other online websites that support this functionality.
Customer geo-location data when shopping, or using the mobile application or website to access product data and prices, including using a barcode, QR Code, NFC or RFID tag, image recognition, or other product scanning technology.

According to certain embodiments of the disclosed subject matter, an electronic shopping system/service can predict the purchasing interval and next purchases dates of products based on the customer shopping data discussed above. This can allow for notification of customers and/or automated re-ordering of the products they purchase on a periodic basis. The algorithm used to do this can be both a “learning” algorithm, in that it is able to make better predictions as it obtains additional data, and an “adaptive” algorithm, in that it is able to adjust the model(s) used to make predictions to choose the one best suited to the current user and data. Purchase recommendations can be transmitted to the users via means including, but not limited to, email, SMS, “push” notifications, and via the website and mobile app. An algorithm which becomes more predictive with additional data input may be considered a “learning” algorithm; common non-proprietary examples include artificial neural networks, Bayesian networks, and certain implementations of a support vector machine (SVM). An example of an “adaptive” algorithm which adjusts itself based on data inputs is the OpenForecast Java library.

In one example, an electronic shopping system/service can set initial customer purchase interval based on similar users determined by the data in their initial registration. The electronic shopping system/service can use one or more machine learning techniques (i.e. Linear Regression, Logistic Regression, Support Vector Machine (with various kernels), Neural Network, Clustering or others) to group users. Exact algorithm(s) used can be selected based upon back-testing on existing data. This type of prediction can be more heavily weighted for new users. The electronic shopping system/service can also customize purchase interval based upon that user's later actions and acquired profiling information, as discussed above. The electronic shopping system/service can use pattern-smoothing algorithms to determine a user-specific purchasing interval, can create a variation overlay for seasonal and other effects based on similar users, and can use pattern recognition and data mining algorithms on the database of Purchase Predictive Data to discover other predictive information and patterns.

FIG. 4 illustrates an exemplary process 400 of predicting product due date according to some embodiments of the disclosed subject matter. The exemplary process 400 can be executed on an electronic shopping server (described in more details later).

At step 410, product purchase intervals of a user can be calculated. For example, the number of days between consecutive purchase dates of a product for the user is calculated.

At step 420, user product lifetime can be calculated. A fair estimate of the purchase interval for a user given a product can be obtained by taking an exponential moving average of the product purchase intervals given calculated in step 410.

Recursive formula:User product Lifetime(UPLₜ)=α(PIₜ₋₁)+(1−α)UPIₜ₋₁

Non Recursive Formula:User product Lifetime(UPLₜ)=α(PIₜ₋₁+(1−α)PIₜ₋₂+(1−α)²PIₜ₋₃+(1−α)³PIₜ₋₄+(1−α)⁴PIₜ₋₅ . . . )

wherein,

α—decay coefficient (between 0 and 1)

PI—Product Purchase Intervals

At step 430, final product lifetime can be calculated. The final estimate of the product life can be made by taking a weighted mean of the global product lifetime and the user product lifetime (calculated in step 420).

Final Product Lifetime(FPL)=UPL+(PL−UPL)*(N_{conf}(N_{conf}+N_{obs}))

wherein

PL—Global product lifetime (Average of product lifetime over all users)

N_{conf}—Parameter to tune FPL between UPL and PL. It reflects the number of user purchase intervals required to provide a confident estimate of the product lifetime.

N_{obs}—Length of the Product Purchase Interval array.

At step 440, product due date can be calculate. There can include two scenarios:

a) If the user has hit a buy later button for the above product after the last time he purchased it:

Predicted Due Date=Buy_Later_Date+FPL/2

b) If the user has not used buy later for the above product:

Predicted Due Date=Last_Product_Purchase_Date+FPL

FIG. 5 illustrates an exemplary process 500 of recommending products according to some embodiments of the disclosed subject matter. The exemplary process 500 can be executed on an electronic shopping server (described in more details later).

At step 510, user data can be collected and normalized. The user data can include the user profile data and the list of products bought by a user. The user profile data can include age, gender, number of people in household. FIG. 6 illustrates examples of user profile characteristics and lists of products bought. The user profile data collected can then be normalized. As each of the profile parameters can have a different range of values, they can be normalized and scaled to similar ranges so that none of the parameters bias the similarity measurement.

$$Normalized value = \frac{value - min value among all}{range}$$

For example: if age=25, min age in all the data collected=20, range of values of age is 60(20 to 80), normalized age=5/60.

At step 520, user data can be considered as points in an N-dimension space. FIG. 7 illustrates an exemplary three-dimension space. Each point in this 3-dimension space can have 3 parameters (one in each dimension). Similar to that, if there are X user profile characteristics and Y products in all, each user can be represented as a point in an N-dimension space, where N=X+Y.

At step 530, K other users with similar profile data and buying patterns can be identified. Considering users as points in an N-dimension space as discussed above, the following metrics can be utilized to identify similar users:

a) Euclidean distance (actual distance between the points in space)
x=(x₁, x₂, x₃, . . . , xₙ) is a vector in an n-dimensional vector space

If x₁ and x₂ are vectors:

Euclidean distance=sqrt((x₁₁−x₂₁)²+(x₁₂−x₂₂)²+(x₁₃−x₂₃)²+ . . . +(x₁ₙ−x₂ₙ)²)

b) Cosine distance (angle between the vectors in space)
x=(x₁, x₂, x₃, xₙ) is a vector in an n-dimensional vector space
Length of x is given by (extension of Pythagoras's theorem)

|X|²=x₁²+x₂²+x₃²+ . . . +xₙ²
If x₁ and x₂ are vectors:
   Inner product (or dot product) is given by:

x₁·x₂=x₁₁x₂₁+x₁₂x₂₂+x₁₃x₂₃+ . . . +x₁ₙx₂ₙ
Cosine of the angle between the vectors x₁ and x₂ is:

$$cos ( θ ) = \frac{{x}_{1} \cdot {x}_{2}}{\vert {x}_{1} \vert \vert {x}_{2} \vert}$$

For each user, the distance from this user to all other users can be calculated. Then the top K users can be identified, e.g., based on similarity (most similar=least distance in space/maximum cosine similarity)

At step 540, products can be recommend to the current user (U_{cur}). P products from the K most similar users that are not bought by the current user can be recommended to the current user. For example,
a) Find all the products bought by the K users, not in the tracking list of the current user
b) Take a majority vote of these products by counting number of K users that have bought these products. This vote can also be weighted by the similarity of the users
   Un-weighted vote for product Pᵢ

$${WP}_{i} = {\sum }_{u = 1}^{K} \begin{matrix}1 if Product i is bought by u \\ 0 if Product i not bought by u\end{matrix}$$

Weighted vote for product Pᵢ

$${WP}_{i} = {\sum }_{u = 1}^{K} \begin{matrix}sim ( u , Ucur ) * 1 if Prod i is bought by u \\ 0 if Product i not bought by u\end{matrix}$$

c) After the above weights are calculated for all the products bought by ‘K’ users but not U_{cur}, top P products are recommended to the user.

According to certain embodiments of the disclosed subject matter, an electronic shopping system/service can provide dynamic aisles to customers. The electronic shopping system/service can provide customized search results to each user on the website, mobile application, or other searching or ordering platform (i.e. an in store kiosk) based on the past behavior of one or more users. This can make the shopping experience faster, less frustrating, and more intuitive for the customer. For example, searching “breakfast” can supply a list of breakfast items tailored to the predicted preferences of the actual user, rather than simply a list of results for products containing the word “breakfast.” These results can be derived from the same data sources as the purchasing interval prediction, and can make use of the same clustering or categorization techniques used to group similar users for purchase internal prediction.

In one example, initial basic aisles can be manually created. Then, items that are frequently purchased together may be clustered together to form an aisle; items that are frequently searched close together may be clustered together to form an aisle; items that are frequently purchased with items already in a user's cart are prioritized in search results; items with the same tag may be grouped into an aisle if there are enough items so tagged, and if they are purchased or searched together often enough; and items previous purchased by the user, tracked by the user, or recommended for the user are prioritized in the user's dynamic aisles.

According to certain embodiments of the disclosed subject matter, an electronic shopping system/service can be implemented in a client/server environment like the ones illustrated in FIGS. 1 and 2. An electronic shopping server can include an electronic shopping service engine. FIG. 8 illustrates a block diagram of an exemplary electronic shopping service engine 800 according to one embodiment of the disclosed subject matter. The electronic shopping service engine 800 can include a purchase predictive data collector 810, a product purchase interval predictor 820, a product recommender 830, and a dynamic aisle manager 840.

The purchase predictive data collector 810 can collect purchase predictive data of a user. More details about purchase predictive data can be found in other sections of this document. The purchase predictive data collector 810 can also normalize the purchase predictive data of the user. In addition, the purchase predictive data collector 810 can manage and store the collected data on the electronic shopping server or other servers.

The product purchase interval predictor 820 can predict a purchase interval of a product for the user. The prediction can be at least partially based on the purchase predictive data of the user. The product purchase interval predictor 820 can calculate a user product lifetime and a final product lifetime. The product purchase interval predictor 820 can also consider an action of delaying purchase of the product by the user and/or a last purchase of the product by the user when predicting the product purchase interval of the product for the user. More details about predicting product purchase intervals can be found in other sections of this documents (e.g., FIG. 4 and its corresponding descriptions).

The product recommender 830 can recommend additional products to the users. The recommendation can be at least partially based on the purchase predictive data of the user. The product recommender 830 can also consider purchases by other users when recommending the additional products to the user. The product recommender 830 can identify the other users based on their similarities to the user. More details about recommending additional products can be found in other sections of this document (e.g., FIG. 5 and its corresponding descriptions). The product recommender 830 can also provide data analytics and shopper marketing to retailers, wholesalers, and CPG companies. For example, the product recommender 830 can give retailers, wholesalers, CPG companies a better understanding of their customer base and can give them information on stock outs, products growing in popularity, and products that people frequently purchase together. More details about data analytics and shopper marketing can be found in earlier sections of this document.

The dynamic aisle manager 840 can manage a dynamic aisle for the user. The dynamic aisle manager 840 can add the additional products recommended by the product recommender 830 to the dynamic aisle for the user. More details about dynamic aisles can be found in other sections of this documents.

The electronic shopping service engine 800 described above is exemplary only and not limiting. For example, an electronic shopping service engine can have some or all the modules discussed above. An electronic shopping service engine can also include additional modules.

According to certain embodiments of the disclosed subject matter, an electronic shopping system/service can be implemented in a client/server environment like the ones illustrated in FIGS. 1 and 2. FIG. 9 illustrates a block diagram of a computing device 900 that can be used to implement one or more aspects of the functionality described herein. The computing device 900 can serve as, for example, a server 104 in the system environment 100 or an electronic shopping server. The computing device 900 can include at least one processor 902 and at least one memory 904. The processor 902 can be hardware that is configured to execute computer readable instructions such as software. The processor 902 can be a general processor or be an application specific hardware (e.g., an application specific integrated circuit (ASIC), programmable logic array (PLA), field programmable gate array (FPGA), or any other integrated circuit). The processor 902 can execute computer instructions or computer code to perform desired tasks. The memory 904 can include volatile and/or non-volatile computer readable medium, such as flash memory, a magnetic disk drive, an optical drive, a programmable read-only memory (PROM), a read-only memory (ROM), random access memory (RAM), or any other memory or combination of memories.

The computing system 900 can also optionally include a user interface (UI) 906, a file system module 908, and a communication interface 910. The UI 906 can provide an interface for users to interact with the computing device 900. The file system module 908 can be configured to maintain a list of all data files, including both local data files and remote data files, in a file system. The file system module 908 can be further configured to coordinate with the memory 904 to store and cache files/data. The communication interface 910 can allow the computing device 900 to communicate with external resources (e.g., a network or a remote client/server). The computing device 900 can also include an electronic shopping service engine 800. The electronic shopping service engine 800 can have its own user interface. Additionally, the electronic shopping service engine 800 can utilize the UI 906 of the computing system 900. The computer device 900 can include additional modules, fewer modules, or any other suitable combination of modules that perform any suitable operation or combination of operations.

Exemplary operations of an exemplary system according to some embodiments of the disclosed subject matter are illustrated in sample web application screens contained in FIGS. 10A through 10C. FIG. 10A demonstrates a sample web application screen showing tracked items and recommended items. FIG. 10B demonstrates a sample web application screen showing a delay purchase option (e.g., an hourglass button). FIG. 10C demonstrates sample web application screens showing a product detail view with tracking and untracking functionalities.

Exemplary operations of an exemplary system according to some embodiments of the disclosed subject matter are further illustrated in sample mobile application screens contained in FIGS. 11A through 11C. FIG. 11A demonstrates a sample mobile application screen showing tracked items. FIG. 11B demonstrates a sample mobile application screen showing a delay purchase option (e.g., a “Later” button). FIG. 11C demonstrates sample mobile application screens showing a product detail view with tracking and untracking functionalities.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” may not be software per se and can include at least some tangible hardware that is configured to execute computer readable instructions.

1. A computer server for providing an electronic shopping service, comprising:
a purchase predictive data collector configured to collect purchase predictive data of a user;
a product purchase interval predictor configured to predict a product purchase interval of a product for the user at least partially based on the purchase predictive data of the user; and
a product recommender configured to recommend additional products to the user at least partially based on the purchase predictive data of the user and to provide data analytics and shopper marketing to retailers, wholesalers, or consumer packaged goods (CPG) companies.

2. The computer server of claim 1, wherein the purchase predictive data collector is further configured to normalize the purchase predictive data of the user.

3. The computer server of claim 1, wherein the product purchase interval predictor is further configured to calculate a user product lifetime and a final product lifetime.

4. The computer server of claim 1, wherein the product purchase interval predictor is further configured to consider an action of delaying purchase of the product by the user when predicting the product purchase interval of the product for the user.

5. The computer server of claim 1, wherein the product purchase interval predictor is further configured to consider a last purchase of the product by the user when predicting the product purchase interval of the product for the user.

6. The computer server of claim 1, wherein the product recommender is further configured to consider purchases by other users when recommending the additional products to the user.

7. The computer server of claim 6, wherein the product recommender is further configured to identify the other users based on their similarities to the user.

8. The computer server of claim 1, wherein the product recommender is further configured to identify purchasing opportunities to increase sales for at least one of the retailers, the wholesalers, or the CPG companies.

9. The computer server of claim 1, wherein the product recommender is further configured to analyze customers of the electronic shopping service.

10. The computer server of claim 1, further comprising a dynamic aisle manager configured to maintain a dynamic aisle for the user.

11. The computer server of claim 10, wherein the dynamic aisle manager is further configured to add the additional products to the dynamic aisle for the user.

12. The computer server of claim 1, further comprising a third-party integration interface configured to interact with at least one third-party.

13. The computer server of claim 12, wherein the at least one third-party includes at least one of a retailer, a wholesaler, and a consumer packaged goods (CPG) company.

14. A computerized method of providing electronic shopping service, comprising:
automatically collecting purchase predictive data of a user by a purchase predictive data collector;
predicting a product purchase interval of a product for the user at least partially based on the purchase predictive data of the user by a product purchase interval predictor;
recommending additional products to the user at least partially based on the purchase predictive data of the user by a product recommender; and
providing data analytics and shopper marketing to retailers, wholesalers, or consumer packaged goods (CPG) companies.

15. The computerized method of claim 14, further comprising normalizing the purchase predictive data of the user.

16. The computerized method of claim 14, further comprising calculating a user product lifetime and a final product lifetime.

17. The computerized method of claim 14, further comprising considering an action of delaying purchase of the product by the user when predicting the product purchase interval of the product for the user.

18. The computerized method of claim 14, further comprising considering a last purchase of the product by the user when predicting the product purchase interval of the product for the user.

19. The computerized method of claim 14, further comprising considering purchases by other users when recommending the additional products to the user.

20. The computerized method of claim 19, further comprising identifying the other users based on their similarities to the user.

21. The computerized method of claim 14, further comprising identifying purchasing opportunities to increase sales for at least one of the retailers, the wholesalers, or the CPG companies.

22. The computerized method of claim 14, further comprising interacting with at least one third-party.

23. The computerized method of claim 22, wherein the at least one third-party includes at least one of a retailer, a wholesaler, and a consumer packaged goods (CPG) company.
